(19) United States
(12) Patent Application Publication
(10) Pub. No.: US 2017/0026455 A1
(43) Pub. Date: Jan. 26, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Hiromoto ANDO, Kanagawa (JP); Yoshimi UEZU, Kanagawa (JP); Chie OHARA, Kanagawa (JP); Masayuki KONO, Kanagawa (JP)

(73) Assignee: FUJI XEROX CO., LTD., Tokyo (JP)

(21) Appl. No.: 15/094,291

(22) Filed: Apr. 8, 2016

(30) Foreign Application Priority Data
Jul. 21, 2015 (JP) 2015-143933

(51) Int. Cl. H04L 29/08

(52) U.S. Cl. CPC H04L 67/06

(57) ABSTRACT

An information processing apparatus includes an acquisition unit and a help controller. The acquisition unit acquires information indicating whether help information is stored in any of information processing apparatuses within the same group as the information processing apparatus. The help controller performs control based on the information acquired by the acquisition unit so as to cause an information processing apparatus within the group to acquire the help information from an external help management apparatus if the help information is not stored in any of the information processing apparatuses within the group or to cause an information processing apparatus within the group to acquire the help information from another information processing apparatus storing the help information in the group if the help information is stored in any of the information processing apparatuses within the group.

### CROSS-REFERENCE TO RELATED APPLICATIONS

This application is based on and claims priority under 35 USC 119 from Japanese Patent Application No. 2015-143933 filed Jul. 21, 2015.

### BACKGROUND

### Technical Field

The present invention relates to information processing apparatuses, information processing methods, and non-transitory computer readable media.

### SUMMARY

According to an aspect of the invention, there is provided an information processing apparatus including an acquisition unit and a help controller. The acquisition unit acquires information indicating whether help information is stored in any of information processing apparatuses within the same group as the information processing apparatus. The help controller performs control based on the information acquired by the acquisition unit so as to cause an information processing apparatus within the group to acquire the help information from an external help management apparatus if the help information is not stored in any of the information processing apparatuses within the group or to cause an information processing apparatus within the group to acquire the help information from another information processing apparatus storing the help information in the group if the help information is stored in any of the information processing apparatuses within the group.

### BRIEF DESCRIPTION OF THE DRAWINGS

Exemplary embodiments of the present invention will be described in detail based on the following figures, wherein:

FIG. 1 illustrates an example of the configuration of a system according to an exemplary embodiment;

FIG. 2 illustrates an example of the configuration of a management apparatus;

FIG. 3 illustrates an example of group management information stored in the management apparatus;

FIG. 4 illustrates an example of the configuration of an image forming apparatus serving as a master unit of a help group;

FIG. 5 illustrates an example of group information stored in the master unit;

FIG. 6 illustrates an example of help management information stored in each image forming apparatus;

FIG. 7 illustrates an example of the configuration of an image forming apparatus serving as a slave unit;

FIG. 8 illustrates an example of master-unit information stored in the slave unit;

FIG. 9 illustrates an example of the procedure of a process performed by the master unit that has received a command from a user for displaying a help item;

FIG. 10 illustrates an example of the procedure of a process performed by the slave unit that has received a command from a user for displaying a help item;

FIG. 11 illustrates an example of the procedure of a process performed by the master unit that has received a request for a help item from the slave unit;

FIG. 12 illustrates an example of the procedure of a help-information acquisition process performed by each image forming apparatus in a periodical mode;

FIG. 13 illustrates an example of the procedure of a help-information acquisition process performed by each image forming apparatus in an error mode;

FIG. 14 illustrates an example of the procedure of a process performed by the master unit that has received a command from a user for displaying a help item, in accordance with a first modification; and

FIG. 15 illustrates an example of the procedure of a process performed by the master unit in accordance with a second modification.

### DETAILED DESCRIPTION

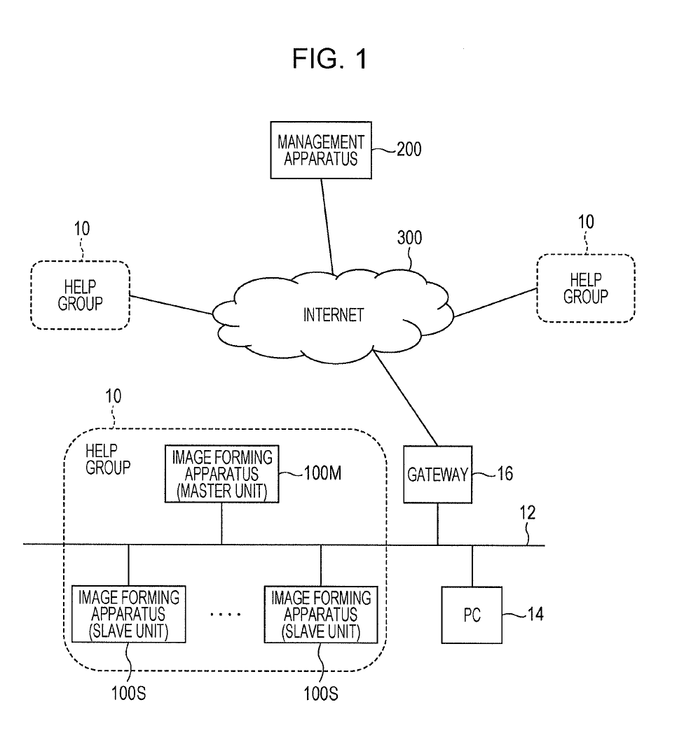

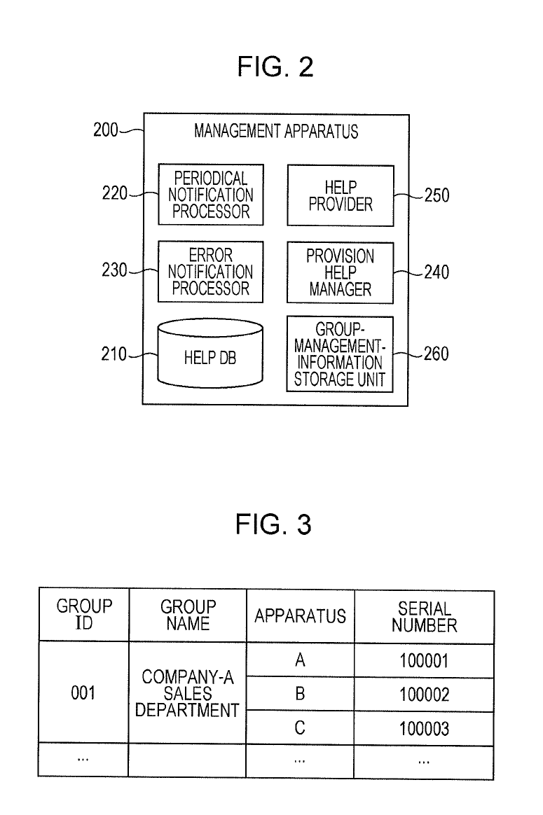

The configuration of a system according to an exemplary embodiment of the present invention will be described with reference to FIG. 1. As shown in FIG. 1, the system according to this exemplary embodiment includes one or more help groups 10 connected to the Internet 300, and a management apparatus 200.

Each help group 10 is constituted of multiple image forming apparatuses 100M or 100S (which will be collectively referred to as “image forming apparatuses 100” hereinafter if they are not to be distinguished from each other) that are capable of using the same help information. The expression “capable of using help information” with respect to a certain image forming apparatus 100 implies that the help information is suitable with respect to the image forming apparatus 100. The help information of each image forming apparatus 100 includes many descriptions (individual help descriptions will be referred to as “help items” hereinafter), such as a description explaining how to use an individual function of the image forming apparatus 100 and a description explaining how to deal with various possible errors (disorders). The expression “the multiple image forming apparatuses 100 are capable of using the same help information” normally corresponds to, but not limited to, a case where the multiple image forming apparatuses 100 are all capable of using all of the multiple help items (e.g., the multiple image forming apparatuses 100 are of the same model or system). For example, the concept of the expression “the multiple image forming apparatuses 100 are capable of using the same help information” also includes a case where each help group 10 is constituted of three image forming apparatuses 100 of A, B, and C, the image forming apparatuses A and B are capable of using help items a and b, and the image forming apparatuses B and C are capable of using help items b and c.

Multiple image forming apparatuses 100 belonging to one help group 10 are connected to the same local network 12, such as a local area network or an intranet, and are communicable with each other. A user inputs a print command to an image forming apparatus 100 from a personal computer (PC) 14 via the local network 12. The local network 12 is connected to the Internet 300 via a gateway 16, such as a firewall. Furthermore, an image forming apparatus 100 not belonging to the help group 10 may also exist in the local network 12.

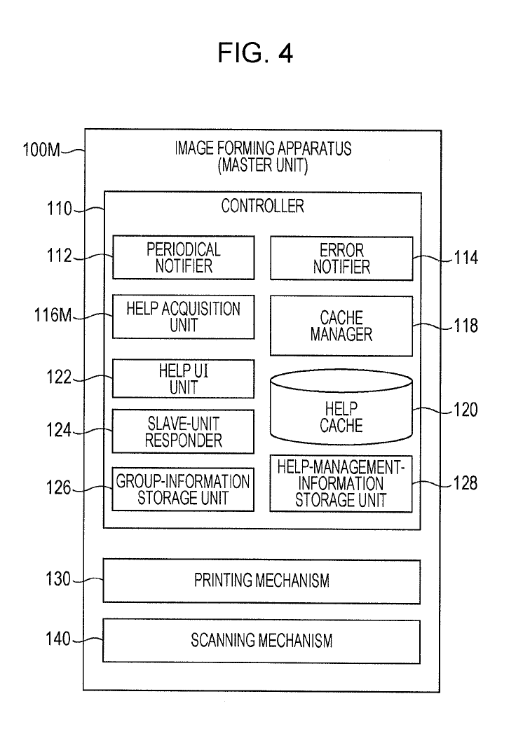

Each image forming apparatus 100 is, for example, a printer, a scanner, a copier, a facsimile apparatus, or a multifunction apparatus equipped with one or more of these functions. As shown in FIG. 3 or 4, each image forming apparatus 100 includes a printing mechanism 130 for printing and a scanning mechanism 140 for optically reading a document, and performs processes, such as printing, scanning, and copying, by using these mechanisms. However, this is merely an example, and the technique according to this exemplary embodiment is applicable to an image forming apparatus having a single function, such as a printing function alone or a scanning function alone. Each image forming apparatus 100 is connected to the Internet 300 via the gateway 16 or, for example, a portable telephone network.

The image forming apparatuses 100 within each help group 10 include a master unit 100M and slave units 100S. One master unit 100M is provided within each help group 10 and ascertains which help item is cached in each image forming apparatus 100 within the help group 10. If a help item desired by a user does not exist in a help item group cached in a slave unit 100S, the slave unit 100S first makes a request for the help item to the master unit 100M instead of immediately acquiring the help item from the management apparatus 200. If the help item desired by the user exists in the master unit 100M or another slave unit 100S in the help group, the help item is provided to the request source so that the management apparatus 200 does not have to provide the help item.

The management apparatus 200 provides help information to each image forming apparatus 100. The help information may be provided based on a push method in which the management apparatus 200 actively provides the help information even if there is no request from an image forming apparatus 100, or based on a pull method in which the management apparatus 200 provides the help information in response to a request from an image forming apparatus 100, such as a hypertext transfer protocol (HTTP) request. A method suitable for the environment, such as the network, in which the image forming apparatuses 100 are installed may be used. For example, the management apparatus 200 acquires, from each image forming apparatus 100, management information indicating, for example, the usage status of the image forming apparatus 100 and information related to an error occurring in the image forming apparatus 100. In accordance with the acquired information, the management apparatus 200 identifies help information with a high possibility of being beneficial for the image forming apparatus 100 and provides the identified help information to the image forming apparatus 100. Information, such as the management information and the error information of the image forming apparatus 100, used by the management apparatus 200 for identifying the help information to be provided has many similarities with information acquired from the image forming apparatus 100 by a server for remote maintenance. Thus, the server that performs remote maintenance may additionally have the function of the management apparatus 200 according to this exemplary embodiment that provides help information.

The management apparatus 200 and the image forming apparatuses 100 will be described below in further detail.

The management apparatus 200 has a help database (DB) 210, a periodical notification processor 220, an error notification processor 230, a provision help manager 240, a help provider 250, and a group-management-information storage unit 260.

The help DB 210 is a database that stores help information. A large number of help items are stored in the help DB 210. Each help item includes a help ID for uniquely identifying the item and help contents of help information with respect to the item. The help contents are the contents of a help description corresponding to the topic of the relevant help item and include, for example, a description of an operation method for a specific operation of an image forming apparatus 100 or a description of a method for dealing with a specific error.

Furthermore, the help DB 210 may contain list-of-help-contents information indicating the list of contents of a help item group usable by each help group 10 and search index information used for searching for individual help items. Each heading included in the list of contents is linked to the help item corresponding to the heading. Thus, by selecting a heading, the corresponding help item is accessible. By using the search index information, a help item corresponding to a keyword input by a user is retrievable. In a case where the management apparatus 200 corresponds to multiple models of image forming apparatuses 100, the help DB 210 stores, for each model, list-of-help-contents information and a help item group corresponding to the model.

The periodical notification processor 220 processes management information of each image forming apparatus 100 periodically notified by a periodical notifier 112 of the image forming apparatus 100 so as to identify a help item group with a high possibility of being used by the image forming apparatus 100 at the time of the notification.

In this process, the periodical notification processor 220 determines an event, such as an error that may occur in the image forming apparatus 100 in the near future with a high possibility (e.g., toner shortage, paper jam, replacement time for a photoconductor drum), in accordance with each item value of the notified management information. This determination may be performed by using a related-art technique of predicting the occurrence of an error in the image forming apparatus 100 or predictively detecting the occurrence of an error. This determination may be performed in view of not only the currently notified management information but also management information notified in the past. Then, the periodical notification processor 220 identifies a help item corresponding to each event determined that it may occur in the image forming apparatus 100 in the near future with a high possibility as a help item with a high possibility of being beneficial for the image forming apparatus 100 at the current time point. The correspondence relationship between the events and the help items are registered in advance in a database within the management apparatus 200, and the periodical notification processor 220 refers to this database to identify a help item corresponding to each event determined that it may occur in the near future with a high possibility. Then, the periodical notification processor 220 associates the identified help item group (e.g., the help IDs of the help items) with identification information (referred to as “apparatus ID”) of the image forming apparatus 100 and registers the identified help item group in the provision help manager 240.

Based on error information notified by an error notifier 114 of the image forming apparatus 100, the error notification processor 230 identifies a help item indicating a method for dealing with an error indicated by the error information. Then, the identified help item is associated with the apparatus ID of the image forming apparatus 100 and is registered in the provision help manager 240.

The provision help manager 240 is a functional module that manages a help item group to be provided to each image forming apparatus 100. The provision help manager 240 stores a help ID of a help item identified by the periodical notification processor 220 and the error notification processor 230 with respect to the image forming apparatus 100 in association with the apparatus ID of the image forming apparatus 100.

The help provider 250 receives a help acquisition request from a help acquisition unit 116M or 116S of an image forming apparatus 100 and transmits a help item to the image forming apparatus 100 in response to the request. First, as one example, when the help provider 250 receives a help acquisition request that designates a help ID to be desirably acquired, the help provider 250 reads the help item corresponding to the help ID from the help DB 210 and replies to the image forming apparatus 100. If a help acquisition request that does not designate a help ID is received from the image forming apparatus 100, the help provider 250 reads, from the help DB 210, help items corresponding to respective help IDs stored within the provision help manager 240 in association with the apparatus ID of the image forming apparatus 100. Then, the read help item group is transmitted to the image forming apparatus 100 as a response to the help acquisition request. With regard to the help items transmitted to the image forming apparatus 100, the help provider 250 deletes the apparatus ID of the image forming apparatus 100 and the help IDs of the help items from the provision help manager 240.

Although not shown in the drawings, the management apparatus 200 has a user interface (UI) function for an operator (human) who responds to inquiries from users of the image forming apparatuses 100 by, for example, telephone or chatting. This UI function is provided to the operator via a display device attached to the management apparatus 200 or via a computer on a network accessible to the management apparatus 200. The operator responds to an inquiry from each user and uses the UI function so as to register a help item useful for the inquiry in the provision help manager 240 in association with the apparatus ID of the relevant image forming apparatus 100. The registered help item is to be transmitted to the image forming apparatus 100 by the help provider 250 when a help acquisition request arrives from the image forming apparatus 100.

Furthermore, when a new function is added to each image forming apparatus 100 as a result of, for example, updating of the version of software that controls the image forming apparatus 100, a help item with respect to the function is added to the help DB 210. Then, the list-of-help-contents information and the search index information corresponding to the image forming apparatus 100 are updated to new versions in which the added help item is reflected. In a case where such updating is performed, the updated list-of-help-contents information and the updated search index information are registered in the provision help manager 240 in association with the apparatus ID of each image forming apparatus 100 of the relevant model. Subsequently, when a help acquisition request arrives from an image forming apparatus 100, if list-of-help-contents information is registered in association with the apparatus ID of the image forming apparatus 100, for example, the registered list-of-help-contents information is transmitted to the image forming apparatus 100.

The group-management-information storage unit 260 stores management information of each help group 10. FIG. 3 illustrates an example of the management information stored in the group-management-information storage unit 260. In this example, the management information includes, for each help group 10, a name (“group name”) of the help group 10 and an apparatus name (“apparatus”) and a serial number of each image forming apparatus 100 belonging to the help group 10 in association with a group ID, which is identification information unique to the help group 10. A serial number is a unique consecutive number given to each image forming apparatus 100 by the manufacturer and is used as identification information of the image forming apparatus 100. Although not shown, with regard to the master unit 100M, information indicating that it is a master unit is stored in the management information thereof.

Next, the image forming apparatuses 100 will be described in detail. First, the image forming apparatus 100M serving as a master unit will be described.

The image forming apparatus 100M (master unit) has a controller 110, a printing mechanism 130, and a scanning mechanism 140.

The printing mechanism 130 is a mechanical mechanism for printing an image onto a medium by using ink or toner. The scanning mechanism 140 generates an electric image signal by optically reading a document.

The controller 110 is an information processing device that controls the image forming apparatus 100M. Although the controller 110 has various types of functions for controlling the printing mechanism 130 and the scanning mechanism 140 and for performing, for example, a UI process using an input-output device, such as a touchscreen, functions related to the management of help information (i.e., the periodical notifier 112 to a help-management-information storage unit 128) are specifically illustrated in FIG. 4.

The periodical notifier 112 notifies the management apparatus 200 of management information of the image forming apparatus 100 on a periodical basis, such as once a day or once a week. The management information to be notified is to be used for the management of the image forming apparatus 100 and indicates, for example, the usage status of the image forming apparatus 100. The management information is a group of one or more information items indicating, for example, the past usage history or the current status of the image forming apparatus 100 or consumables (such as a toner cartridge) or replacement parts (such as a photoconductor drum) attached to the image forming apparatus 100. The management information includes items such as billing meter information (e.g., a counter value indicating the number of printed sheets for each of a monochrome item and a color item), operation counter information for each service, consumables information (e.g., the remaining amount of toner), usage frequency information of periodical replacement parts (e.g., the usage amount of a photoconductor drum), failure history information, and operational information of the printing mechanism 130. These information items may be items similar to notification information that the image forming apparatus 100 periodically provides to a maintenance center for remote maintenance.

The error notifier 114 notifies the management apparatus 200 of information (error information) related to an error that has occurred in the image forming apparatus 100. This error information includes, for example, an error code for uniquely identifying the type of error that has occurred. Moreover, the error information may also include further detailed information about the contents of the error. The error information to be transmitted to the management apparatus 200 by the error notifier 114 may be similar to the error notification information that the image forming apparatus 100 provides to the maintenance center for remote maintenance. The notification of the error information to the management apparatus 200 from the error notifier 114 may be performed automatically when the error occurs or may be performed when an acquisition command for help information with respect to the occurred error is received from the user.

A help acquisition unit 116M acquires help information from, for example, the management apparatus 200. Operation modes of the help acquisition unit 116M include an individual acquisition mode in which a help item explicitly designated by the user is acquired, a periodical mode in which a help item is periodically acquired when there is no error occurring in the image forming apparatus 100, and an error mode corresponding to when an error occurs.

In the individual acquisition mode, for example, a help item selected by the user from a list of help contents or a search result is acquired from the management apparatus 200. However, with regard to a help item stored in a help cache 120 in the image forming apparatus 100M or in a help cache 120 in a slave unit 100S within the same help group 10, the help item is not acquired from the management apparatus 200. Instead, the help item in one of the help caches 120 is used.

In the periodical mode, the help acquisition unit 116M acquires a help item desired by the management apparatus 200 in accordance with periodical notification from the periodical notifier 112. The help acquisition process in the periodical mode is performed with the same frequency as, for example, the notification from the periodical notifier 112. In one example, the help acquisition unit 116M acquires a help item from the management apparatus 200 at a timing subsequent by a predetermined time to a timing at which the periodical notifier 112 performs periodical notification. In a detailed example, the periodical notifier 112 is scheduled to provide notification to the management apparatus 200 every weekday at 9 a.m., and the help acquisition unit 116M is scheduled to acquire a help item group 15 minutes later, that is, every weekday at 9:15 a.m., by performing polling on the management apparatus 200. The time difference between the notification from the periodical notifier 112 and the corresponding help acquisition by the help acquisition unit 116M may be set in view of the time it takes for the management apparatus 200 to identify a help item suitable for the image forming apparatus 100 based on periodically notified information.

In the error mode, the help acquisition unit 116M acquires a help item desired by the management apparatus 200 in accordance with notification of error information from the error notifier 114. When an error occurs in the image forming apparatus 100 and the error notifier 114 correspondingly notifies the management apparatus 200 of error information, the help acquisition unit 116M switches from the periodical mode to the error mode. Then, when a help item corresponding to the error in the error mode is acquired from the management apparatus 200, the error mode is canceled.

In the periodical mode, the polling interval for help information is a long interval (e.g., one day) corresponding to the notification interval of the periodical notifier 112. In contrast, in the error mode, the polling interval is set to a short interval, such as every minute, so as to acquire the help item corresponding to the error information as quickly as possible.

The help item acquired by the help acquisition unit 116M is transmitted to a cache manager 118. Furthermore, if the acquired help item corresponds to a command from a help UI unit 122, the help item is also transmitted to the help UI unit 122.

The cache manager 118 manages the help cache 120. More specifically, the cache manager 118 performs a process for storing the help item acquired by the help acquisition unit 116M into the help cache 120 as well as a process for deleting a help item from the help cache 120 for increasing the available space.

The help cache 120 is a storage unit that stores help items. The help cache 120 stores therein, for example, a help item group acquired from, for example, the management apparatus 200, list-of-help-contents information, and search index information.

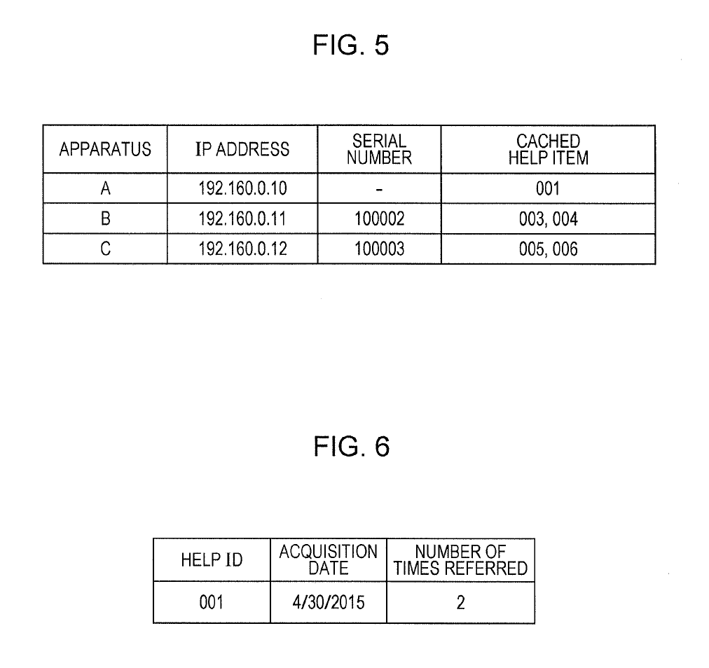

The help UI unit 122 performs a UI process for displaying or printing help information for the user. For example, the help UI unit 122 displays the list-of-help-contents information on a screen of the image forming apparatus 100. When the user selects the heading of an item of which the user desires to see detailed information from the displayed list of contents, the help UI unit 122 searches for the help item corresponding to the selected heading from the help cache 120. When the target help item is found in the help cache 120, for example, the help contents of the help item are displayed on the screen. If the target help item is not found, it is determined whether the help item is stored in any of the slave units 100S within the help group 10. This determination is performed based on group information stored in a group-information storage unit 126. This group-information storage unit 126 will be described later with reference to FIG. 5. If the determination result indicates that the help item is stored, the help item is acquired from the relevant slave unit 100S and is displayed on the screen, and the acquired help item is stored into the help cache 120. If it is determined that the help item does not exist within the relevant help group 10, a request for the help item is made to the management apparatus 200, and the help item provided in response to the request is displayed on the screen and is stored into the help cache 120. In response to a command from the user, the help UI unit 122 may print and output the help contents instead of or in addition to displaying the help contents on the screen.

In a case where an error occurs in the image forming apparatus 100, the help UI unit 122 displays a help item related to the error on the screen. If a help item corresponding to an error code of the occurred error exists in the help cache 120, the help UI unit 122 displays the help item. In a case where the help code does not exist in the help cache 120, the help item is first acquired from any of the slave units 100S in the help group 10 and is displayed if the relevant help item exists in the slave unit 100S, similarly to the above-described case where a help item corresponding to a command from the user is displayed. If the help item does not exist in any of the slave units 100S, the help item corresponding to the error code is acquired from the management apparatus 200 and is displayed. This display may be performed automatically without user confirmation or may be performed when there is a reply indicating that the display is to be performed after inquiring the user about whether or not the display is to be performed.

A slave-unit responder 124 responds to help-item requests from the slave units 100S in the help group 10. In this response, if a requested help item exists in the help cache 120 of the master unit 100M, the help item is provided. If the request help item does not exist in the help cache 120 of the master unit 100M, the relevant help item is provided to the slave unit 100S acting as the request source if the help item exists in any of the slave units 100S in the help group 10, similarly to the above-described case where a help item corresponding to a command from the user is displayed. If the help item does not exist in any of the slave units 100S, the help item is acquired from the management apparatus 200 and is provided to the slave unit 100S acting as the request source.

The group-information storage unit 126 stores group information to be used for managing the help group 10. FIG. 5 illustrates an example of the group information. In the example in FIG. 5, the group information includes, for each image forming apparatus 100 belonging to the relevant help group 10, an apparatus name (“apparatus”), an IP address, a serial number, and a cached help item list of the image forming apparatus 100. The apparatus name and the serial number are similar to those described with reference to FIG. 3. An IP address is to be used when communicating via the local network 12 and may be a private address. A cached help item list includes help IDs of help items cached in the respective help caches 120 of the master unit 100M and the slave units 100S within the help group 10.

If each slave unit 100S stores a new help item into the help cache 120 or deletes a help item from the help cache 120 to avoid capacity shortage of the help cache 120, the slave unit 100S notifies the master unit 100M of the help ID of the relevant help item. In accordance with the notification, the master unit 100M updates the cached help item list of the relevant slave unit 100S within the group-information storage unit 126.

The help acquisition unit 116M and the slave-unit responder 124 refer to this group-information storage unit 126 so as to determine whether or not a requested help item exists within the help group 10.

The help-management-information storage unit 128 stores management information of each help item stored in the help cache 120. FIG. 6 illustrates an example of the management information stored in the help-management-information storage unit 128. The management information in this example includes, for each help item stored in the help cache 120, a help ID of the help item, an acquisition date, and the number of times referred. An acquisition date indicates the date on which the image forming apparatus 100M has acquired and cached the help item. The number of times referred indicates the number of times the user has referred to the help item. For counting the number of times referred, the number of times referred may be limited to the number of times the help item is referred to in the image forming apparatus 100M, or the number of times referred may include a case where the help item is provided in response to a request from any of the slave units 100S. The acquisition date and the number of times referred are to be used for determining a help item to be deleted from the help cache 120 when there is not enough available space in the help cache 120. A help item to be deleted may be selected by using a known cache algorithm, such as least recently used (LRU).

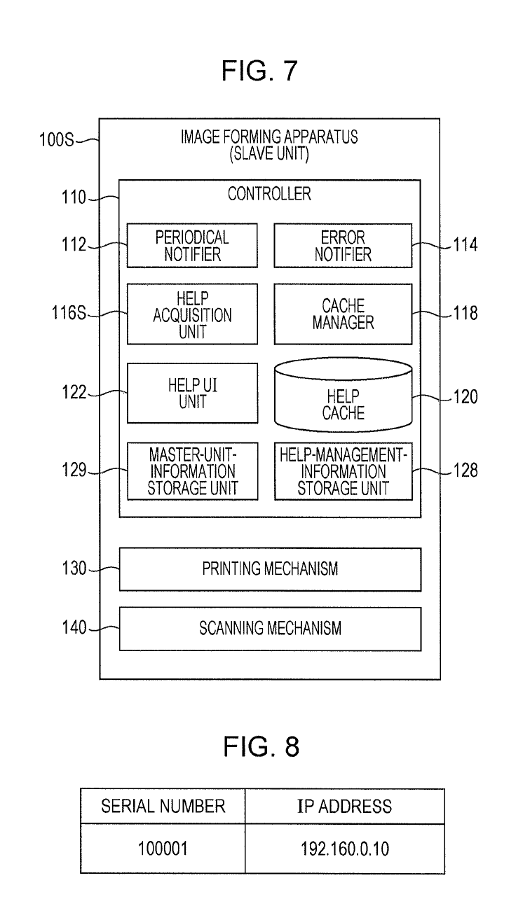

Next, an example of the configuration of an image forming apparatus 100S serving as a slave unit will be described with reference to FIG. 7. Elements similar to the elements in the master unit 100M are given the same reference signs, and descriptions thereof are omitted.

A help acquisition unit 116S acquires help information. The help acquisition unit 116S is similar to the help acquisition unit 116M of the master unit 100M in having an individual acquisition mode, a periodical mode, and an error mode as operation modes. The periodical mode and the error mode are similar to those of the help acquisition unit 116M, whereas the individual acquisition mode is slightly different from that of the help acquisition unit 116M.

In the individual acquisition mode, for example, when a help item to which a user desirably refers is selected from a list of help contents or a search result, the help acquisition unit 116S first checks whether the help item exists in its own help cache 120. If the help item exists in the help cache 120, the help acquisition unit 116S displays the help item. If not, the help acquisition unit 116S makes a request for the help item to the master unit 100M and displays the help item provided from the master unit 100M in response to the request.

A master-unit-information storage unit 129 stores information to be used for communicating with the master unit 100M. FIG. 8 illustrates an example of such information. In this example, the master-unit-information storage unit 129 stores a serial number and an IP address of the master unit 100M. The image forming apparatus 100S communicates with the master unit 100M by using the IP address stored in the master-unit-information storage unit 129 and, for example, transmits a request for a help item in the above-described individual acquisition mode.

A help-management-information storage unit 128 of the slave unit 100S is similar to that of the master unit 100M in storing therein a help ID, an acquisition date, and the number of times referred with respect to each help item stored in the help cache 120 of the slave unit 100S.

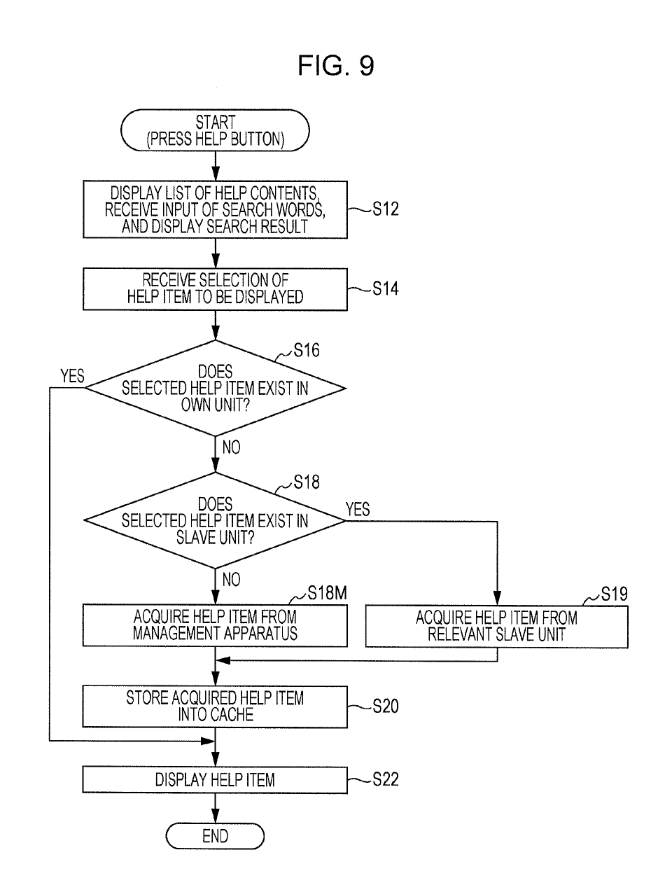

Next, the procedure of a process performed by the help UI unit 122 and the help acquisition unit 116M of the master unit 100M in the individual acquisition mode will be described with reference to FIG. 9.

This process commences when the user presses a help button in an operable section (e.g., a UI screen displayed on a touchscreen) of the master unit 100M. In this case, the help UI unit 122 first displays a list of help contents on a screen in step S12. In the list of help contents, for example, the headings of respective help items are listed in a predetermined order, and each heading has help ID information embedded therein. In the list of help contents to be displayed, the heading of a help item group cached in the master unit 100M or any of the slave units 100S within the help group 10 may have a title, such as “frequently-referred help”. Based on the information within the group-information storage unit 126, the master unit 100M is capable of generating such a list of help contents.

In addition to the list of help contents described above, the help UI unit 122 may display an input section for search words on the screen. Then, in step S12, a help item corresponding to a search word input to the input section by the user is searched by using the search index information, and the heading or headings of one or more help items obtained as a search result is/are displayed on the screen.

The user selects a help item (heading) that the user desires to refer to from the list of help contents or the search result displayed on the screen. In step S16, the help UI unit 122 checks whether the selected help item (i.e., the help item corresponding to the help ID associated with the selected heading) exists in the help cache 120 of the master unit 100M. If the help item exists in the help cache 120 of the master unit 100M, the help UI unit 122 reads the help item and displays the help item on the screen in step S22.

If the help item selected by the user does not exist in the help cache 120 of the master unit 100M, the help UI unit 122 determines in step S18 whether or not the help item is cached in any of the slave units 100S within the help group 10 based on the group information (see FIG. 5) stored in the group-information storage unit 126. If a positive determination result is obtained, the help acquisition unit 116M acquires the help item from the slave unit 100S in which the help item is cached in step S19. For example, an acquisition request including the help ID of the help item is transmitted to the relevant slave unit 100S, and the help item is acquired in response to this request. Then, the help acquisition unit 116M stores the acquired help item into the help cache 120 in step S20 and also transmits the help item to the help UI unit 122. In step S22, the help UI unit 122 displays the received help item on the screen.

If it is determined in step S18 that there is no slave unit 100S caching the help item in the help group 10, the help acquisition unit 116M acquires the help item from the management apparatus 200 in step S18M, stores the help item into the help cache 120 in step S20, and transmits the help item to the help UI unit 122. The help UI unit 122 displays the received help item on the screen in step S22.

In this example, the help item is cached into the master unit 100M in step S20 whether the help item is acquired from any of the slave units 100S within the help group 10 (step S19) or from the management apparatus 200 (step S18M). However, in the case where the help item is acquired from any of the slave units 100S in step S19, since the help item is already cached in the help group 10, the process for caching the help item into the master unit 100M in step S20 may be not performed. Thus, a state in which the same help item is cached in multiple image forming apparatuses 100 within the help group 10 may be reduced, thereby allowing for an efficient use of the cache space in the entire help group 10. Alternatively, in the case where the help item is acquired from any of the slave units 100S in the help group 10 in step S19 and is cached into the master unit 100M in step S20, the help item may be deleted from the help cache 120 of the master unit 100M. In this case, because the help item moves from the master unit 100M to the slave unit 100S, the master unit 100M reflects this movement on the group information (see FIG. 5) within the group-information storage unit 126.

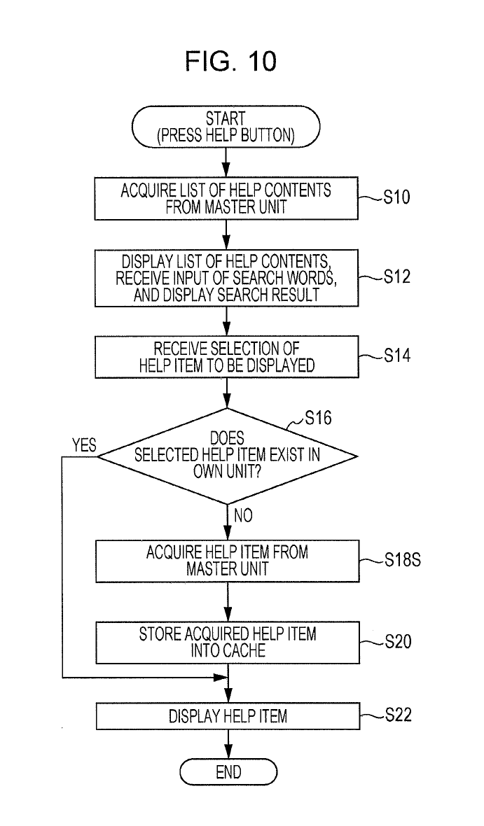

Next, the procedure of a process performed by the help UI unit 122 and the help acquisition unit 116S of each slave unit 100S in the individual acquisition mode will be described with reference to FIG. 10. In this procedure, steps similar to the steps in the procedure of the master unit 100M shown in FIG. 9 are given the same reference signs, and descriptions thereof are omitted.

In this procedure, when a help button is pressed, the slave unit 100S may first acquire the list of help contents from the master unit 100M in step S10. The reason for acquiring the list of help contents from the master unit 100M is to display a list of help contents (in particular, the list of contents of “frequently-referred help” items) in which the most recent cache status of each image forming apparatus 100 within the help group 10 is reflected. Steps S12 to S16 are identical to those in the procedure of the master unit 100M (see FIG. 9).

If it is determined in step S16 that a help item selected by the user does not exist in the slave unit 100S, the help acquisition unit 116S makes a request for the help item by accessing the master unit 100M using information, such as the IP address of the master unit 100M within the master-unit-information storage unit 129 (see FIG. 8), and acquires the help item in step S18S. Then, the help item acquired from the master unit 100M is stored into the help cache 120 in step S20 and is transmitted to the help UI unit 122. In step S22, the help UI unit 122 displays the received help item on the screen.

In this example, the help item acquired from the master unit 100M within the help group 10 is cached into the slave unit 100S serving as the request source in step S18S.

Alternatively, if the help item is cached in the master unit 100M or another slave unit 100S, the process for caching the help item into the slave unit 100S serving as the request source in step S18S may be not performed. On the other hand, if the master unit 100M acquires the help item from the management apparatus 200 in response to a request from the slave unit 100S and transmits the help item to the slave unit 100S, the help item may be not cached into the master unit 100M but may be cached into the slave unit 100S.

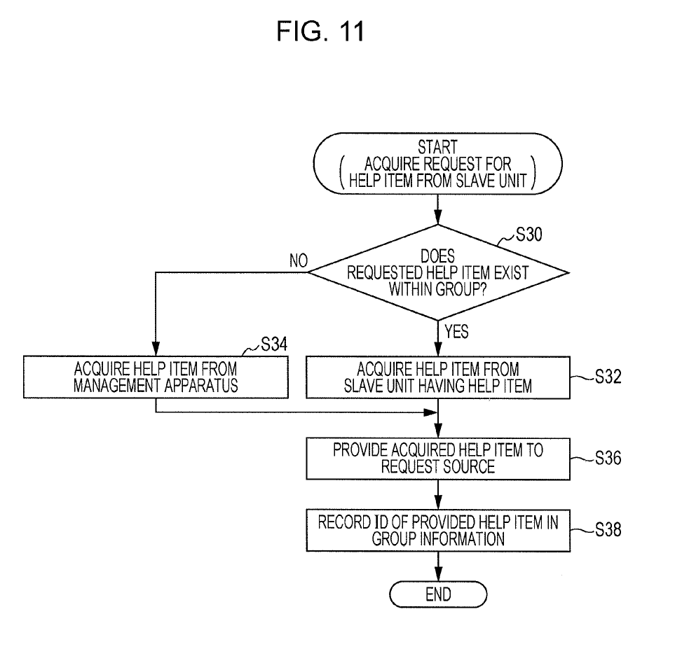

Next, an example of the procedure of a process performed by the slave-unit responder 124 when the master unit 100M receives a request for a help item from any of the slave units 100S (step S18S in FIG. 10) will be described with reference to FIG. 11.

In this procedure, it is determined in step S30 whether the help ID (and the help item corresponding thereto) included in the request from the slave unit 100S is cached within the help group 10 based on the group information (see FIG. 5) within the group-information storage unit 126. If this determination result indicates YES, the slave-unit responder 124 acquires the help item from the slave unit 100S recorded in the group information (see FIG. 5) as caching the help item in step S32. If it is determined in step S30 that the requested help item does not exist in the help group 10, the slave-unit responder 124 makes a request for the help item to the management apparatus 200 and acquires the help item transmitted from the management apparatus 200 in response to the request in step S34. After step S32 or S34, the slave-unit responder 124 transmits the acquired help item to the slave unit 100S serving as the request source in step S36 and adds the ID of the transmitted help item to the “cached help item” section of the slave unit 100S serving as the request source in the group information (see FIG. 5) in step S38. In the case where the help item acquired in step S32 from another slave unit 100S within the help group 10 is provided to the slave unit 100S serving as the request source in step S36, if a method of not redundantly caching the help item into the slave unit 100S serving as the request source is employed, the group information is not updated in step S38.

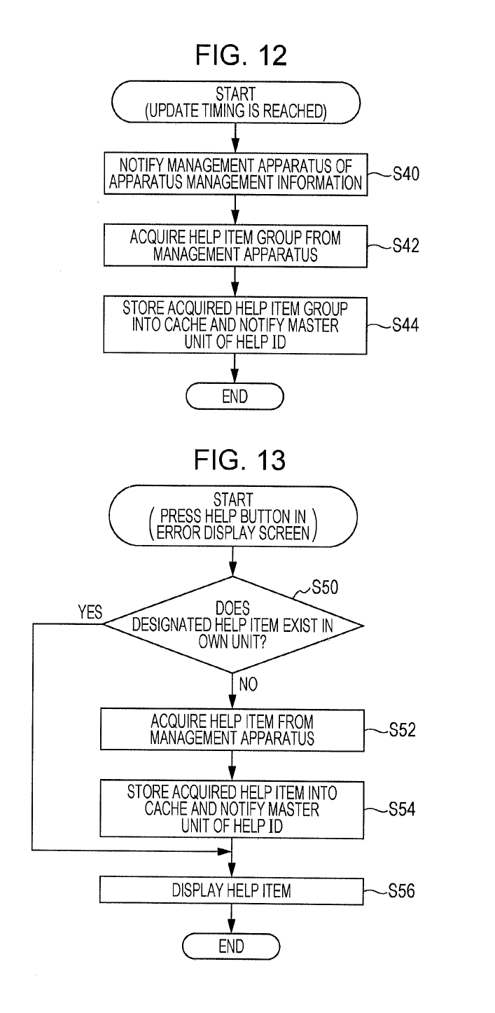

Next, an example of the procedure of a process performed by the periodical notifier 112 and the help acquisition unit 116S of each slave unit 100S in the periodical mode will be described with reference to FIG. 12.

In this procedure, when an update timing determined in accordance with a preset condition (e.g., 9 a.m. and 6 p.m. on weekdays) is reached, the periodical notifier 112 notifies the management apparatus 200 of the management information (e.g., billing meter information, operation counter information for each service, and remaining-amount information of consumables) of the slave unit 100S in step S40. Based on the management information acquired from the slave unit 100S, the management apparatus 200 determines an event, such as an error that may occur in the slave unit 100S in the near future with a high possibility, by using, for example, the aforementioned prediction detection technique in the related art and determines a help item group with a high possibility of being useful for the event. For example, when a certain period of time elapses after the notification in step S40, the help acquisition unit 116S accesses the management apparatus 200 to inquire about whether there is a help item corresponding to periodical notification. If there is a help item corresponding to periodical notification, the help acquisition unit 116S acquires the help item in step S42. Then, the acquired help item is stored into the help cache 120 within the slave unit 100S, and the master unit 100M is notified of the help ID of the help item in step S44. The master unit 100M that has received this notification adds the notified help ID to the “cached help item” section of the entry of the slave unit 100S in the group-information storage unit 126. When caching the acquired help item in step S44, if a help item is deleted from the help cache 120, the master unit 100M may also be notified of the help ID of the deleted help item. In this case, the master unit 100M deletes the ID of the notified help item from the “cached help item” section of the slave unit 100S.

The management information of which the slave unit 100S periodically notifies the management apparatus 200 may include information (which is recorded by the slave unit 100S) about the recent usage frequency of functions in the slave unit 100S. In accordance with the received information about the usage frequency of functions, if there is a frequently-used function (e.g., with a frequency indication value larger than a predetermined threshold value), the management apparatus 200 may add the help item related to the function as one of help items to be provided to the slave unit 100S in accordance with the notification.

Although FIG. 12 corresponds to the procedure of the process performed by each slave unit 100S, the procedure of a process performed by the master unit 100M in the periodical mode may be substantially similar to the procedure shown in FIG. 12. The only difference is that, in the case of the master unit 100M, the “cached help item” section thereof in the group-information storage unit 126 is updated in step S44.

Although each slave unit 100S acquires help item information corresponding to periodical notification from the management apparatus 200 in the example shown in FIG. 12, this is merely an example. Alternatively, in place of the slave units 100S within the help group 10, the master unit 100M may acquire help items corresponding to periodical notification with respect to the slave units 100S and transfer the acquired help items to the corresponding slave units 100S.

Next, an example of the procedure of a process performed by the help acquisition unit 116S and the help UI unit 122 of each slave unit 100S in the error mode will be described with reference to FIG. 13.

When an error (e.g., a failure in a certain part) occurs in the slave unit 100S, an error display screen indicating the occurrence of the error is displayed, and a help button included in the error display screen is pressed, this process is executed. In this case, the help UI unit 122 checks whether a help item corresponding to an error code on the error display screen exists in the help cache 120 of the slave unit 100S in step S50. If the help item exists in the help cache 120 of the slave unit 100S, the help item is displayed in step S56. If the help item does not exist in the help cache 120 of the slave unit 100S, the help acquisition unit 116S makes a request for the help item corresponding to the error code to the management apparatus 200 and acquires the help item transmitted in response to the request in step S52. Then, in step S54, the acquired help item is stored into the help cache 120 in the slave unit 100S, and the master unit 100M is notified of the help ID of the help item. Moreover, in step S56, the help item is transmitted to the help UI unit 122 so as to be displayed on the screen.

In this example, since the help is related to an error that involves urgency, the slave unit 100S acquires a help item directly from the management apparatus 200 (without intervention of the master unit 100M). However, in the case of an error, the slave unit 100S may make a request for a relevant help item to the master unit 100M, similarly to the case of the individual acquisition mode.

Although FIG. 13 corresponds to the procedure of the process performed by each slave unit 100S, the procedure of a process performed by the master unit 100M in the error mode may be substantially similar to the procedure shown in FIG. 13. The only difference is that, in the case of the master unit 100M, the “cached help item” section thereof in the group-information storage unit 126 is updated in step S54.

One exemplary embodiment has been described above. In this exemplary embodiment, if a help item that a user commands each image forming apparatus 100 for reference exists within the help group 10, a request for the help item is not transmitted to the management apparatus 200.

### First Modification

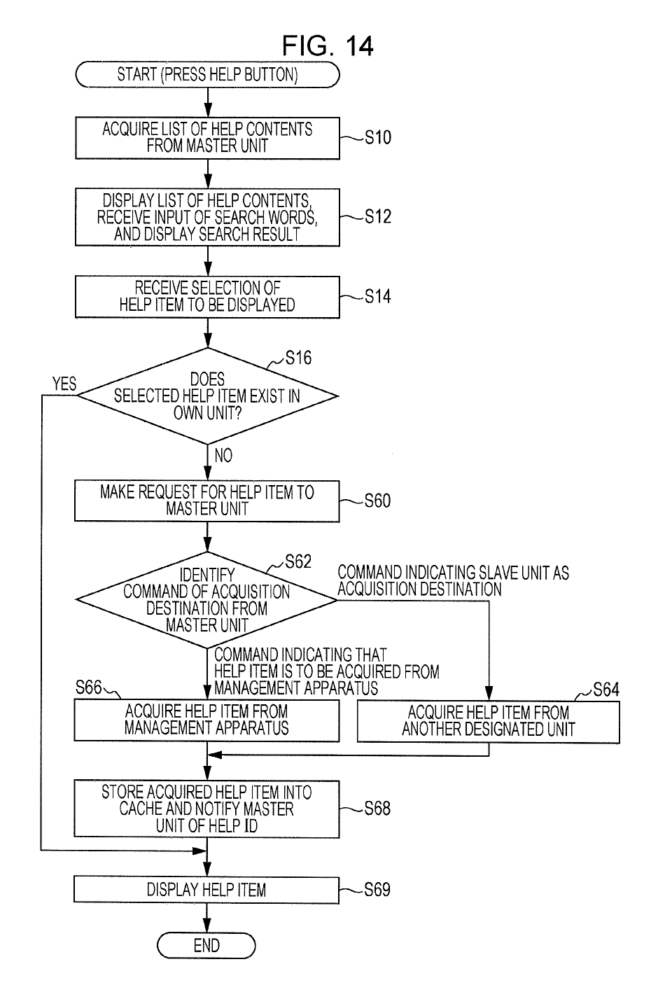

In the exemplary embodiment described above, a help item requested by any of the slave units 100S is acquired from another slave unit 100S or the management apparatus 200 by the master unit 100M in place of that slave unit 100S. In contrast, in this modification, the slave unit 100S serving as the request source performs the acquisition process. The procedure of a process performed by the help UI unit 122 and the help acquisition unit 116S of each slave unit 100S in the individual acquisition mode in this modification will be described below with reference to FIG. 14.

The procedure shown in FIG. 14 is similar to the procedure shown in FIG. 10 in terms of steps S10 to S16.

If it is determined in step S16 that a help item selected by the user does not exist in the slave unit 100S, the help acquisition unit 116S makes a request for the help item to the master unit 100M in step S60. Then, in step S62, it is determined whether a command from the master unit 100M in response to the request is a command indicating a slave unit as the acquisition destination or a command indicating that the help item is to be acquired from the management apparatus 200.

In this case, the “command indicating a slave unit as the acquisition destination” may include a uniform resource locator (URL) (e.g., http://192.160.0.11/help_file/003.html) of the help item in the slave unit serving as the acquisition destination. The URL includes an IP address of the slave unit caching the help item, a folder name “help_file” indicating the help cache 120, and a file name “003.html” (“003” being the help ID of the help item) of the help item within the folder, which are arranged in this order. Likewise, the “command indicating that the help item is to be acquired from the management apparatus 200” may include a URL of the help item within the management apparatus 200.

In the case where the command from the master unit 100M is the “command indicating a slave unit as the acquisition destination”, the help acquisition unit 116S acquires the help item from the designated slave unit serving as the acquisition destination in step S64. For example, if the command includes the URL of the help item, the help acquisition unit 116S may use the URL to acquire the help item based on HTTP. If the command from the master unit 100M is the “command indicating that the help item is to be acquired from the management apparatus 200”, the help item is acquired from the management apparatus 200 in step S66. In this case, if the command includes the URL of the help item, the help acquisition unit 116S may acquire the help item by using the URL.

After step S64 or S66, the help acquisition unit 116S stores the acquired help item into the help cache 120 within the slave unit 100S and notifies the master unit 100M of the help item in step S68. The master unit 100M that has received this notification adds the notified help ID to the “cached help item” section of the entry of the slave unit 100S in the group-information storage unit 126. The acquired help item is displayed on the screen by the help UI unit 122 in step S69.

The procedure of a process performed by the master unit 100M according to this modification in the individual acquisition mode may be the same as that shown in FIG. 9.

Furthermore, the slave-unit responder 124 of the master unit 100M according to this modification operates as follows when a request for a help item is received from any of the slave units 100S. Specifically, when it is ascertained that the help item exists in the master unit 100M or any of the slave units 100S based on the group information (see FIG. 5) within the group-information storage unit 126, the slave-unit responder 124 transmits a command including the image forming apparatus 100M or 100S, which has the help item, as the acquisition destination, to the slave unit 100S serving as the request source. For example, by combining the IP address of the master unit 100M or the slave unit 100S storing the help item, a preset folder name of the help cache 120, and the help ID of the help item, the URL of the help item is generated. The generated URL is then provided to the slave unit 100S serving as the request source. If it is ascertained that the requested help item does not exist in the help group 10, a command indicating that the help item is to be acquired from the management apparatus 200 is transmitted to the slave unit 100S serving as the request source. For example, the URL of the help item stored in the management apparatus 200 (which may alternatively be, for example, stored in the list of help contents provided from the management apparatus 200) is provided to the slave unit 100S serving as the request source.

### Second Modification

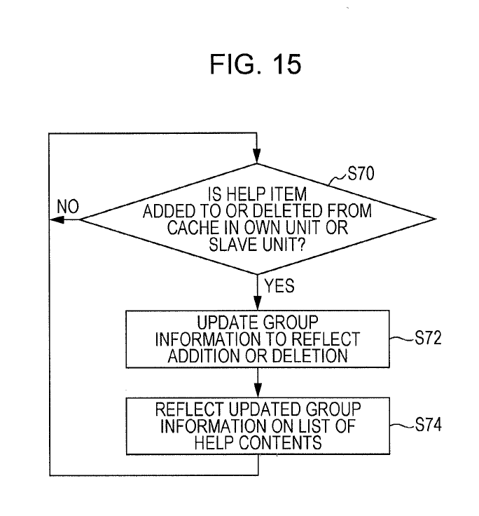

A second modification will now be described with reference to FIG. 15. In the exemplary embodiment and the first modification described above, control is performed such that if a help item desired by a user does not exist within each slave unit 100S, the slave unit 100S makes a request for the help item to the master unit 100M, and the master unit 100M responds to the request so that the slave unit 100S may acquire the help item. In contrast, in this modification, such a request from the slave unit 100S to the master unit 100M is not made. Alternatively, in this modification, the group information managed by the master unit 100M (see the data contents in the group-information storage unit 126 in FIG. 5) is reflected on, for example, the list of help contents to be provided to the slave unit 100S (step S10 in FIG. 10) from the master unit 100M. For example, the URLs of help items corresponding to headings in the list of help contents are set for the respective headings so that when the user selects one of the headings, the help item indicated by the corresponding URL is acquired based on HTTP. With regard to a help item not cached in any of the master unit 100M and slave units 100S within the help group 10, the URL of the relevant help item within the management apparatus 200 is set for the corresponding heading within the list of help contents. On the other hand, with regard to a help item cached in any of the master unit 100M and slave units 100S within the help group 10, the URL of the relevant help item within the master unit 100M or the slave unit 100S caching the help item is set for the corresponding heading. By using the list of help contents configured in this manner, a request for a help item made to the management apparatus 200 from any of the image forming apparatuses 100 within the help group 10 only corresponds to a case where a help item selected by the user is not cached in the help group 10.

As shown in FIG. 15, in this modification, the master unit 100M adds or deletes a help item to or from the help cache 120 of the master unit 100M or waits until it receives notification indicating that a help item is added to or deleted from the help cache 120 from each slave unit 100S within the same help group 10 in step S70. Then, if such an event occurs (i.e., if the determination result obtained in step S70 indicates YES), the group information (see FIG. 5) is updated in step S72 in accordance with the addition or the deletion, and the addition or the deletion is reflected on the list of help contents in step S74.

For example, the master unit 100M receives an original of the list of help contents provided from the management apparatus 200. This original has set therein the URLs (which designate the help items within the help DB 210) of the help items corresponding to the respective headings as link information for the respective headings. When the master unit 100M confirms that one of the help items is cached in any of the slave units 100S, the master unit 100M renews the URL set for the heading corresponding to the relevant help item in the list of help contents to a URL designating the help item stored in the slave unit 100S. For example, it is assumed that the URL set for the heading of the relevant help item in the original is “http://www.helpmanager.example.co.jp/help_DB/003.html” and that the help item is cached in device B in the example shown in FIG. 5. In this case, the master unit 100M (i.e., device A in FIG. 5) converts, for example, the domain name of the aforementioned URL set for the heading in the list of help contents to a domain name that corresponds to device B. Specifically, for example, the URL is converted to “http://192.160.0.11/help_file/003.html”.

By continuously performing such a maintenance process, the master unit 100M retains a list of help contents to which the up-to-date statuses of the help caches within the help group 10 are reflected. When the user presses a help button, each slave unit 100S may acquire the most-recent list of help contents from the master unit 100M and display the list of help contents on the screen.

### Third Modification

In the above-described exemplary embodiment, the methods for acquiring a help item requested by any of the slave units 100S include a method of causing the master unit 100M to transmit the help item stored in the master unit 100M to the slave unit 100S, a method of causing the slave unit 100S serving as the request source to acquire the help item from another slave unit 100S by commanding the slave unit 100S to acquire the help item from another slave unit 100S, and a method of causing the slave unit 100S serving as the request source to acquire the help item from the management apparatus 200. Based on one of these methods, the slave unit 100S acquires and displays the help item. Moreover, the help item acquired by the slave unit 100S is stored into the help cache 120. In contrast, in this modification, the slave unit 100S may store the help item into the help cache 120 only when the help item is acquired from the management apparatus 200, and may notify the master unit 100M of information related to the stored help item. In a case where the slave unit 100S acquires the help item from a unit within the same help group 10, such as the master unit 100M or another slave unit 100S, the slave unit 100S may discard the help item without storing the help item into the help cache 120.

### Fourth Modification

In the above-described exemplary embodiment, when the master unit 100M or any of the slave units 100S performs periodical notification with respect to the management apparatus 200, an event, such as an error that may occur in the master unit 100M or the slave unit 100S in the near future with a high possibility, is determined by using, for example, a prediction detection technique, and a help item with a high possibility of being useful for the event is acquired by the master unit 100M or the slave unit 100S. In this modification, a help item to be provided based on an error prediction to be provided by the management apparatus 200 may be provided to the master unit 100M or the slave unit 100S by adding, to the help item, information indicating that a deletion (cache-out) process from the help cache 120 is to be excluded. When it is determined that a help item is to be deleted from the help cache 120 in a case where there is not enough available space in the help cache 120, the help-management-information storage unit 128 may exclude the help item having added thereto the information indicating that this deletion is to be excluded from the items to be deleted.

### Other Exemplary Embodiments

In the above exemplary embodiments and modifications, only a single help group 10 is taken into account. In contrast, for example, in a single business establishment having many departments, it is assumed that there are multiple help groups 10. In such a case, for example, when periodically updating the help items (see FIG. 12), the management apparatus 200 may determine a help item to be provided to a certain help group 10 in view of information about other help groups 10 related to the relevant help group 10 (e.g., other help groups 10 belonging to the same business establishment).

For example, the management information of which each image forming apparatus 100 notifies the management apparatus 200 includes information about the number of times (FIG. 6) each help item in the image forming apparatus 100 is referred to. Then, when requesting a help item group, which is to be provided when performing the periodical updating of help items, from the master unit 100M in a certain help group 10, the sum of the number of times referred with respect to each help item in the relevant help group 10 and each help group 10 related thereto and preregistered in the management apparatus 200 is determined. If a help item with a large sum (e.g., a sum that exceeds a preset threshold value) is not cached within the help group 10 serving as a provision destination, the help item is provided to the help group 10. Since there is a high possibility that a help item frequently referred to in another related help group 10 may be used in the relevant help group 10, such help information is provided in advance in accordance with this mechanism.

The controller 110 of each image forming apparatus 100 and the management apparatus 200 described above are realized by causing a general-purpose computer to execute programs that express processes of the functional modules of the apparatuses. The relevant apparatus is not limited to an image forming apparatus and may be applied to an information processing apparatus that is controlled by a general-purpose computer and that provides various types of functions to the user. In this case, the computer has, for example, a circuit configuration in which hardware units are connected via, for example, a bus. Examples of the hardware units include a microprocessor, such as a central processing unit (CPU); memory units (temporary storage units), such as a random access memory (RAM) and a read-only memory (ROM); a hard-disk-drive (HDD) controller that controls an HDD; various types of input-output (I/O) interfaces; and a network interface that performs control for connecting to a network, such as a local area network. Furthermore, this bus may be connected via, for example, an I/O interface to a disk drive for reading and/or writing information from and/or to a portable disk storage medium, such as a compact disc (CD) or a digital versatile disc (DVD), or to a memory reader-writer for reading and/or writing information from and/or to various types of standard portable nonvolatile storage media, such as a flash memory. A program having written therein the processing contents of each functional module described above is stored into a fixed storage device, such as the hard disk drive, via a storage medium, such as a CD or a DVD, or via a communication unit, such as a network, and is installed into the computer. The program stored in the fixed storage device is loaded into the RAM and is executed by the microprocessor, such as the CPU, so that each of the functional modules described above is realized.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires information indicating whether help information is stored in any of information processing apparatuses within a same group as the information processing apparatus; and
a help controller that performs control based on the information acquired by the acquisition unit so as to cause an information processing apparatus within the group to acquire the help information from an external help management apparatus if the help information is not stored in any of the information processing apparatuses within the group or to cause an information processing apparatus within the group to acquire the help information from another information processing apparatus storing the help information in the group if the help information is stored in any of the information processing apparatuses within the group.

2. The information processing apparatus according to claim 1,
wherein when a request for the help information is received from an information processing apparatus within the group, the help controller acquires the help information from the help management apparatus and provides the help information to the information processing apparatus serving as a request source if the help information is not stored in any of the information processing apparatuses within the group, or acquires the help information from another information processing apparatus storing the help information and provides the help information to the information processing apparatus serving as the request source if the help information is stored in any of the information processing apparatuses within the group, and
wherein when the help controller provides the help information to the information processing apparatus serving as the request source, the acquisition unit obtains information indicating that the help information is stored in the information processing apparatus serving as the request source.

3. The information processing apparatus according to claim 1,
wherein the acquisition unit acquires, from each information processing apparatus within the group, information indicating help information stored in each information processing apparatus.

4. The information processing apparatus according to claim 3,
wherein when a request for the help information is received from an information processing apparatus within the group, the help controller commands the information processing apparatus serving as a request source to acquire the help information from the help management apparatus if the help information is not stored in any of the information processing apparatuses within the group, or commands the information processing apparatus serving as the request source to acquire the help information from another information processing apparatus storing the help information if the help information is stored in any of the information processing apparatuses within the group.

5. The information processing apparatus according to claim 3,
wherein based on the information acquired by the acquisition unit, the help controller generates list-of-contents information in which a heading of each piece of help information is associated with storage location information indicating a location where the help information is stored, and provides the generated list-of-contents information to each information processing apparatus within the group.

6. A non-transitory computer readable medium storing a program causing a computer to execute an information processing process, the information processing process comprising:
acquiring information indicating whether help information is stored in any of information processing apparatuses within a same group as an information processing apparatus; and
performing control based on the acquired information so as to cause an information processing apparatus within the group to acquire the help information from an external help management apparatus if the help information is not stored in any of the information processing apparatuses within the group or to cause an information processing apparatus within the group to acquire the help information from another information processing apparatus storing the help information in the group if the help information is stored in any of the information processing apparatuses within the group.

7. An information processing method comprising:
acquiring information indicating whether help information is stored in any of information processing apparatuses within a same group as an information processing apparatus; and
performing control based on the acquired information so as to cause an information processing apparatus within the group to acquire the help information from an external help management apparatus if the help information is not stored in any of the information processing apparatuses within the group or to cause an information processing apparatus within the group to acquire the help information from another information processing apparatus storing the help information in the group if the help information is stored in any of the information processing apparatuses within the group.
